(19) United States
(12) Patent Application Publication
(10) Pub. No.: US 2018/0112725 A1
(43) Pub. Date: Apr. 26, 2018

(54) BELLCRANK ACTUATOR ASSEMBLY FOR MULTI-MODE CLUTCH MODULE

(71) Applicant: BorgWarner Inc., Auburn Hills, MI (US)

(72) Inventors: Calahan CAMPTON, Royal Oak, MI (US); R. Keith MARTIN, Marlette, MI (US); John F. GUZDEK, Clarkston, MI (US); Jennifer KADLEC, West Bloomfield, MI (US)

(21) Appl. No.: 15/565,932

(22) PCT Filed: Apr. 8, 2016
(86) PCT No.: PCT/US2016/026634

§ 371 Date: Oct. 12, 2017

Related U.S. Application Data
(60) Provisional application No. 62/147,685, filed on Apr. 15, 2015.

(51) Int. Cl. F16D 41/16; F16D 41/14; F16D 23/12

(52) U.S. Cl. CPC F16D 41/16; F16D 23/12; F16D 41/14

(57) ABSTRACT

An actuator device (22) for a multi-mode clutch module (8) may be configured to interact with a bellcrank (40) to selectively control movements of a plurality of pawls (18) situated between a driving member (16) and a driven member (12) of the multi-mode clutch module (8). The bellcrank (40) may pivot about a pivot point (42) of the driven member (12). The actuator device (22) may engage the bellcrank (40) for moving the actuator ring (20) between a plurality of angular positions and selectively control the plurality of pawls (18) to allow multiple modes of engagement such that the driving member (16) and the driven member (12) are configured to allow multiple modes of operation of the multi-mode clutch module (8).

### CROSS-REFERENCE TO RELATED APPLICATION

This application is an International Patent Application claiming priority to US 35 U.S.C § 119(e) to U.S. Provisional Patent Application No. 62/147,685 filed on Apr. 15, 2015.

### FIELD OF THE DISCLOSURE

The present disclosure relates generally to clutches for automotive transmissions and, more particularly, relates to multiple mode clutch actuators employed in the operation of such transmissions.

### BACKGROUND OF THE DISCLOSURE

An automotive vehicle typically includes an internal combustion engine containing a rotary crankshaft configured to transfer motive power from the engine through a driveshaft to turn the wheels. A transmission is interposed between engine and driveshaft components to selectively control torque and speed ratios between the crankshaft and driveshaft. In a manually operated transmission, a corresponding manually operated clutch may be interposed between the engine and transmission to selectively engage and disengage the crankshaft from the driveshaft to facilitate manual shifting among available transmission gear ratios.

On the other hand, if the transmission is automatic, the transmission will normally include an internal plurality of automatically actuated clutch units adapted to dynamically shift among variously available gear ratios without requiring driver intervention. Pluralities of such clutch units, also called clutch modules, are incorporated within such transmissions to facilitate the automatic gear ratio changes.

Moreover, the transmission may incorporate numerous sets of gears and the various gears may be structurally comprised of sun gears, intermediate gears such as planet or pinion gears supported by carriers, and outer ring gears. Specific transmission clutches may be associated with specific sets of the selectable gears within the transmission to facilitate the desired ratio changes.

For example, one of the clutch modules of an automatic transmission associated with first (low) and reverse gear ratios may be normally situated at the front of the transmission and closely adjacent the engine crankshaft. The clutch module may include a driving member and a driven member which may be disposed circumferentially about the driving member. The driving and driven members may be configured to operate in multiple modes, and in one non-limiting example the driving member may be drivingly rotatable in only one direction, however other modes may be possible. Alternatively or additionally, the driving member may be drivingly rotatable in a plurality of directions. Moreover, the driving member may be selectively locked to the driven member via an engagement mechanism such as, a roller, a sprag, a pawl, or other known engagement mechanisms. Furthermore, the rotation of the driving member may be effective to directly transfer rotational motion from the engine to the driveline.

In some transmission systems, the driven member may be fixed to an internal case or housing of an associated planetary member of the automatic transmission. Under such circumstances, in a first configurational mode the driving member may need to be adapted to drive in one rotational direction, but freewheel in the opposite direction, in a condition referred to as overrunning. Those skilled in the art will appreciate that overrunning may be particularly desirable under certain operating states, such as when a vehicle is traveling downhill or coasting. Under such circumstance, the driven member may occasionally have a tendency to rotate faster than the driving member. Allowing the driving member to overrun the driven member may provide protection against damage to the engine and/or transmission components.

In a second non-limiting mode, such as when a vehicle may be in reverse gear, the engagement mechanisms may be adapted for actively engaging in both rotational directions of the driving member, thus not allowing for an overrunning condition in either direction.

Because automatic transmissions include pluralities of gear sets to accommodate multiple gear ratios, the reliability of actuators used for automatically switching clutch modules between and/or among various available operating modes is a consistent design concern. Therefore, much effort has been directed to finding ways to assure actuator reliability at competitive costs.

### SUMMARY OF THE DISCLOSURE

In accordance with one aspect of the disclosure, an actuator assembly for use with a multi-mode clutch module is disclosed. The multi-mode clutch module may have an driving member and an driven member, and a plurality of pawls circumferentially positioned between the driving and driven members. The actuator assembly may further include an actuator ring having a torque arm and the actuator ring may be configured to move between a plurality of angular positions, and the actuator ring may be adapted to selectively control movements of the plurality of pawls for locking and unlocking the driving and driven members together. The actuator assembly may further include an actuator device including a housing. Moreover, a translatable plunger may have a first end secured within the housing, and plunger having a second free end. Furthermore, a bellcrank may be pivotally affixed to the driven member and the driven member may be configured to be a non-rotating member, the bellcrank having a first lever and a second lever the first and second levers being adapted to engage the free end of the plunger and the torque arm for moving the actuator ring between the plurality of angular positions. The actuator assembly may be configured to move the actuator ring and selectively control the plurality of pawls to allow multiple modes of engagement such that the driving member and the driven member are configured to allow multiple modes of operation of the multi-mode clutch module.

In accordance with another aspect of the disclosure, an actuator assembly for use with a multi-mode clutch module is disclosed. The multi-mode clutch module may have a driving member and a driven member, and a plurality of pawls circumferentially positioned between the driving and driven members. The actuator assembly may further include an actuator ring having a torque arm extending orthogonally to a rotational axis of the driving member. The actuator ring may be configured to move between a plurality of angular positions and adapted to selectively control movements of the plurality of pawls for locking and unlocking the driving and driven members together. The actuator assembly may further include an actuator device and a translatable plunger having a first end and a free end which may be configured to extend parallel to the rotational axis of the driving member. Moreover, a bellcrank may be pivotally affixed to the driven member and the bellcrank may have a first lever and a second lever, the first and second levers being adapted to engage the free end of the plunger and the torque arm for movement of the actuator ring between the plurality of angular positions. The actuator assembly may move the actuator ring to selectively control the plurality of pawls to allow multiple modes of engagement such that the driving member the driven member are configured to allow multiple modes of operation of the multi-mode clutch module.

These and other aspects and features will be better understood when reading the following detailed description in conjunction with the accompanying drawings.

### BRIEF DESCRIPTION OF DRAWINGS

FIG. 1 is an elevational side view of a multiple mode clutch module that includes an actuator assembly constructed in accordance with the present disclosure.

FIG. 2 is an enlarged view of portion 2 of the clutch module of FIG. 1.

FIG. 2A is a cross-sectional view of the portion of structure depicted in FIG. 2, taken along lines 2A-2A of FIG. 2.

FIG. 3 is an enlarged view of the structure depicted in FIG. 2, albeit shown in a second mode configuration.

FIG. 3A is a cross-sectional view of the portion of structure depicted in FIG. 3, taken along lines 3A-3A of FIG. 3.

FIG. 4 is an elevational side view of the multiple mode clutch module similar to that of FIG. 1 that includes another embodiment of an actuator assembly constructed in accordance with the present disclosure.

FIG. 4A is an enlarged view of portion 4 of the clutch module of FIG. 4 taken along lines 4A-4A of FIG. 4.

FIG. 5 is an elevational side view of the embodiment of the multiple mode clutch module of FIG. 4, albeit shown in a second mode.

FIG. 5A is an enlarged view of portion 5 of the clutch module of FIG. 5 taken along lines 5A-5A of FIG. 5.

FIG. 6 is a flow chart illustrating an exemplary process or method which may be practiced in accordance with an embodiment of the present disclosure.

It should be understood that the drawings are not to scale, and that the disclosed embodiments are illustrated only diagrammatically and in partial views. It should also be understood that this disclosure is not limited to the particular embodiments illustrated herein.

### DETAILED DESCRIPTION

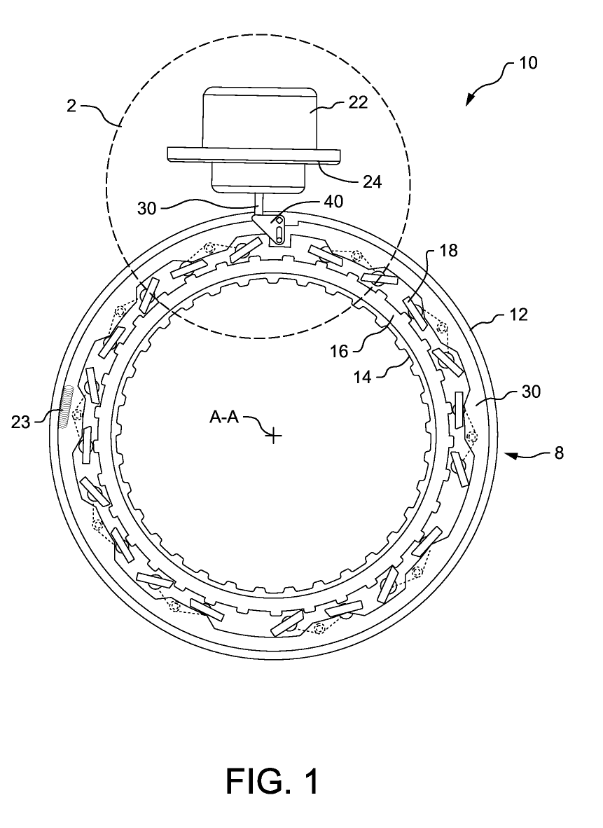

Referring now to the drawings, and with specific reference to FIG. 1, a multiple mode clutch module 8 (also variously called a multi-mode clutch module or MMCM) is depicted. The multi-mode clutch module 8 has an axis “A-A” and may be utilized as a sub-unit of an automatic transmission (not shown), although other uses of the multi-mode clutch module 8 are certainly possible. Such a transmission may be employed in an automobile, for example, and the multi-mode clutch module 8 may utilize an actuator assembly 10, as herein described. The multi-mode clutch module 8 may include an exterior case or housing (not shown), which may act as a non-rotatable driven member, as will be appreciated by those skilled in the art.

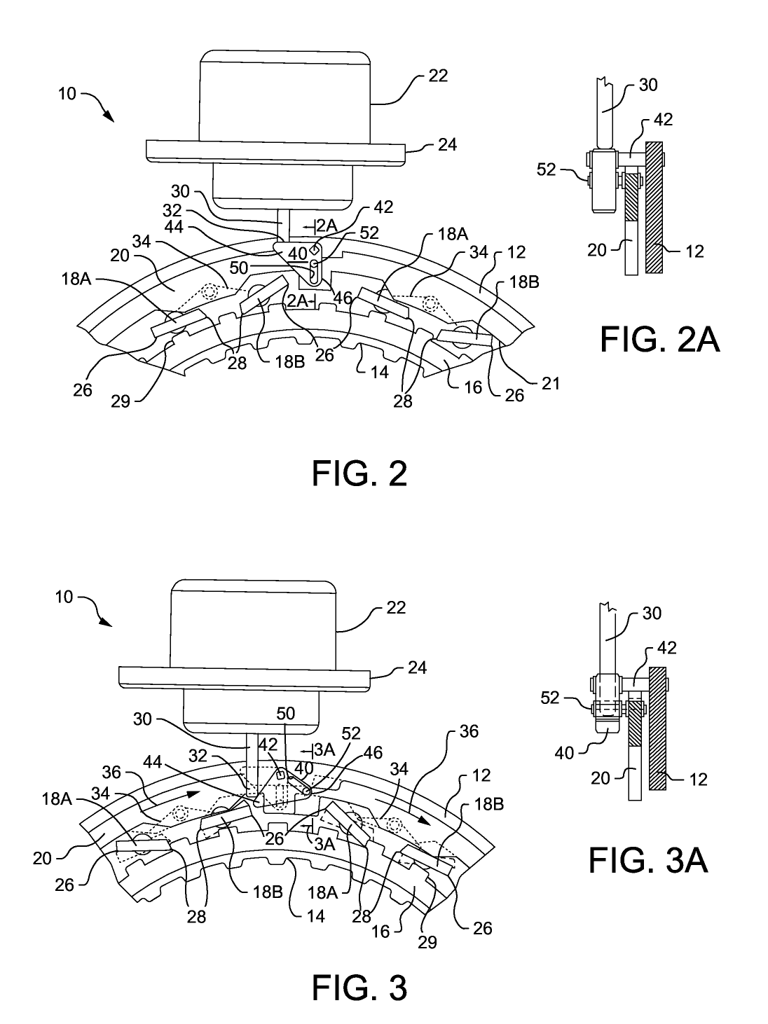

A splined interior driven hub 14 may be adapted for transfer of power from an input, such as an engine (not shown) to an output (not shown). Referring now also to FIG. 2, the driven hub 14 may be integral to a driving member 16, and the driving and driven members 16, 12 may be selectively coupled together by a circumferential arrangement of a plurality of pawls 18.

Controlled movements of the plurality of pawls 18 may be achieved via an actuator ring 20 or cam ring, having radially arranged actuator ring surfaces 21 which may be configured to selectively block or unblock movement of the otherwise spring-loaded plurality of pawls 18. For this purpose, the actuator ring 20 may be rotatable between a plurality of angular limits, as will be appreciated by those skilled in the art.

An actuator device 22, such as a solenoid, a hydraulic actuator, or other known actuator device, may be electrically or hydraulically powered. Moreover, the actuator device may include a housing 24 and a plunger 30 extending from the housing 24. One end (not shown) of the plunger 30 may be attached to a piston or armature (not shown), and may be supported for reciprocal movement within the housing 24 relative to a stator (not shown) fixedly supported within the housing 24. Furthermore, an opposite free end 32 of the plunger 30 may be adapted to interact with a bellcrank 40. In some embodiments, the bellcrank (40) may be rotatable about a pivot point 42 fixed to the driven member 12, however other bellcrank (40) configurations are possible. The bellcrank 40 may have torque arm 52 that is connected or otherwise attached to the actuator ring 20. In some embodiments, the torque arm 52 may be configured to cooperatively engage the bellcrank (40).

Referring now also to FIG. 3, as the plunger end 32 is moved by the actuator device 22, the plunger end 32 may engage a lever arm 44 of the bellcrank 40. In one non-limiting example, this engagement of the lever arm 44 by the plunger end 32 may cause the bellcrank 40 to rotate in a first direction, such as a counterclockwise direction, from its position shown in FIG. 2, however other rotation directions may be possible. Moreover, the rotation in the first direction may force the actuator ring 20 in a second direction, opposite from the first direction as shown by arrows 36, via interaction of the torque arm 52 with the bellcrank 40. Upon being rotated between a minimum of two angular positions (cf FIGS. 2 and 3), the actuator ring 20 may be adapted to selectively block interactions of the plurality of pawls 18 between the driving member 16 and the driven member 12, as will be described.

Those skilled in the art will appreciate that angular movement of the actuator ring 20 may occur against a return spring force of at least one circumferential cam return spring 23 (FIG. 1). For this purpose, the return spring 23 may be anchored on the driven member 12. Upon deactivation of the actuator device 22, the plunger 30 may retract to the position of FIG. 2, and the actuator ring 20 may then be rotated via the cam return spring 23 back towards its initial angular position of FIG. 2.

The limited angular rotation of the actuator ring 20 may be effective to selectively control movement of the plurality of pawls 18 with respect to any given operating mode of the multi-mode clutch module 8. For this purpose, the plurality of pawls 18 are arranged in sets of two, pawls 18A and 18B, each having heel ends 26 and opposite toe ends 28, however other arrangements are possible. As disclosed, the respective sets of pawls 18A and 18B may be asymmetrically shaped, and reversely identical. The heel ends 26 may be configured to interact with the actuator ring surfaces 21 of the actuator ring 20. Moreover, axially oriented, circumferentially spaced notches 29 are provided on the outside periphery of the interior driven hub 14 to be selectively engaged by the toe ends 28. As such, the pawls 18A and 18B may be adapted to normally interact with the notches 29 under the force of pawl springs 34, unless blocked by actuator ring surfaces 21 of the actuator ring 20, to support the desired rotary movements of the driving member 16 about the axis A-A.

In the described configuration, the housing of the multi-mode clutch module 8 may act as the driven member 12, which is rotationally fixed with respect to an associated transmission (not shown). The actuator device 22 (FIGS. 1, 2, and 3) may be fixedly secured to the multi-mode clutch module 8 housing or driven member 12. Furthermore, the actuator ring 20 may also be supported on the fixed driven member 12. In some embodiments, the actuator ring 20 and the driven member 12 may be configured to support the described angular rotations of the driving member 16 about axis A-A.

As depicted and disclosed herein, the plurality of pawls 18 may be elongated hardened steel members circumferentially positioned about the axis A-A of the multi-mode clutch module 8. Alternatively, the plurality of pawls 18 may be forgings or other manufactured structures, otherwise generally adapted to handle required loads of engagement between the driving and driven members 16, 12, as necessary for any particular clutch design.

In view of the foregoing, it will be appreciated that the actuator device 22 may control movement of the actuator ring 20 which, in turn, rotates between the plurality of angular positions. Actual positioning of the pawls 18A and 18B may be directly controlled by the actuator ring surfaces 21 against the forces of the pawl springs 34.

Referring now specifically to FIGS. 2 and 3, when the actuator ring 20 is positioned in a first (FIG. 2) angular position. In one non-limiting example, one set of the opposed pawls, e.g. pawls 18B, may drivingly lock the rotatable driving member 16 to the non-rotatable driven member 12 in only one direction. As a result, the driving member 16 may be locked or otherwise fixed to driven member 12 when the driving member 16 is rotated in a first direction. Moreover, freewheeling of the driving member 16 may occur when the driving member 16 is rotated in a second direction. In some embodiments, the first direction and the second direction may provide a rotation in opposite directions.

Alternatively, when the actuator ring 20 is in a second angular position (FIG. 3), the pawls 18A may lock the driving member 16 to the driven member 12 during the second rotation of the driving member 16,for example to accommodate a reverse gear configuration. Conversely, in the latter angular position of the actuator ring 20, the driving member 16 may be able to freewheel when rotated in the first direction to permit overrunning. In both described configurations of the multi-mode clutch module 8, the driven member 12 is non-rotatable, and hence grounded, relative to an interior case or housing of an associated transmission (not shown).

As disclosed, each individual pawl 18A, 18B is urged radially outwardly via a single spring 34. Although the use of a leaf-style spring is depicted, alternative spring types or even other biasing arrangements may be employed. For example, a pair of coil springs could be used; e.g., one for each pair of opposed pawls 18A, 18B.

The structures herein described may have alternative configurations, although not shown or described herein. For example, the actuator device 22 may be actuated hydraulically instead of electrically. In addition, the biasing system for returning the actuator ring 20 may utilize a spring structure other than a conventional-style coil spring (FIG. 1) as the return spring 23. Although these modifications constitute only two examples, numerous other variations are applicable within the context of this disclosure.

For purposes of this disclosure, the bellcrank actuator assembly 10 may include, but not limited to, the following components:

a) the actuator device 22;

b) the plunger 30;

c) the bellcrank 40;

d) the actuator ring return spring 23; and

e) the actuator ring 20, including the torque arm 52.

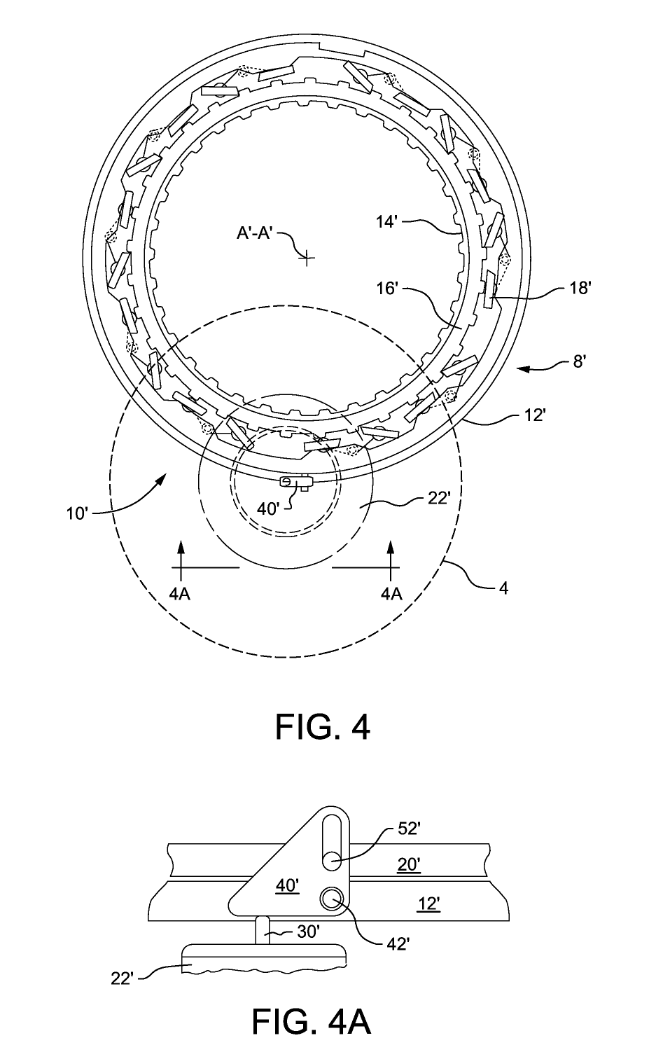

Referring now to FIG. 4, an alternate embodiment of the disclosed actuator assembly 10′ is depicted. In this embodiment, orientation of the actuator 22′ is such that the plunger 30′ may extend parallel to the rotational axis A′-A′ of the driving member 16′ of the multi-mode clutch module 8′. In one non-limiting embodiment, the bellcrank 40′ may have a pivot point 42′ situated orthogonally to the axis A′-A′, and a torque arm 52′ of the actuator ring 20′ extending orthogonally to the axis A′-A′, as well. Moreover, in one non-limiting example the pivot point 42′ may incorporate a pin or other pivotable structure.

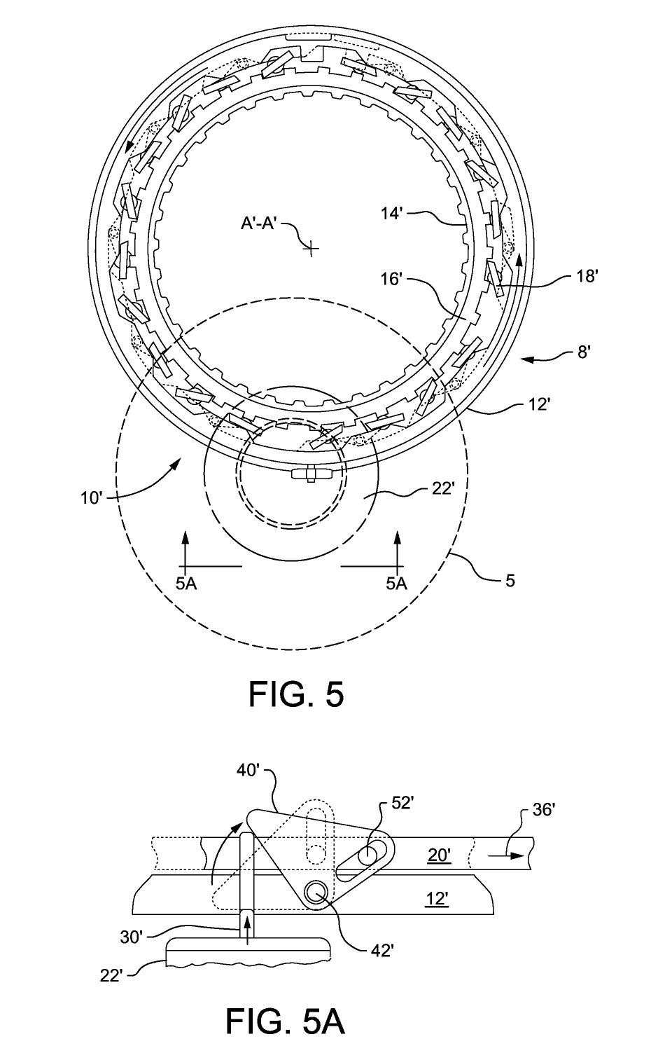

Referring to FIGS. 4A and 5A for comparison purposes, upon actuating the actuator device 22′, extension of the plunger 30′ from the actuator device 22′ may rotate the bellcrank 40′ about the pivot point 42′, and thus in a plane that may be 90° out of phase with the plane of the bellcrank 40 depicted in FIGS. 1-3, however other orientations may be possible. All functional aspects of the two embodiments 10 and 10′ are otherwise identical.

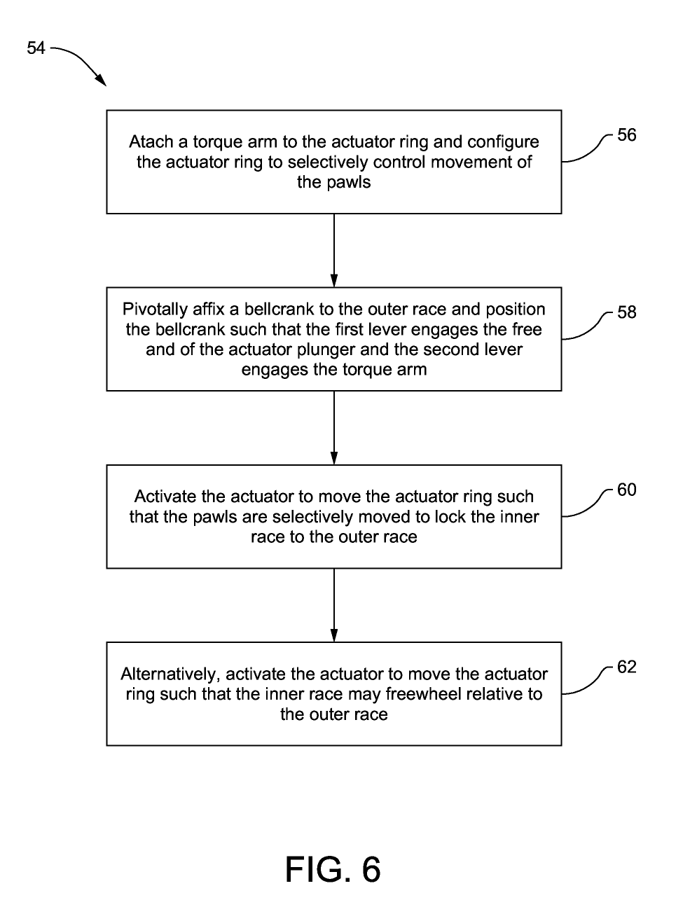

FIG. 6 illustrates an exemplary method or process 54 of using the multi-mode clutch module 8. In a first block 56 the torque arm 52 may be attached to the actuator ring 20 and the actuator ring 20 may be configured to selectively control the movement of the plurality of pawls 18. In the next block 58, the bellcrank 40 may be pivotally affixed to the driven member 12. Furthermore, the bellcrank 40 may be positioned such that the first lever 44 engages the free end 32 of the actuator plunger 30 and the second lever engages the torque arm 52, however other positions of the bellcrank 40 are possible. Moreover, in the next block 60 the actuator 22 may be activated to move the actuator ring 20 in a manner that selectively moves the plurality of pawls 18 and locks the driving member 16 to the driven member 12. Alternatively, in the next block 62 the actuator 22 may be activated to move the actuator ring 20 such that the driving member 16 may be able to freewheel relative to the driven member 12.

### INDUSTRIAL APPLICABILITY

In general, the clutch module, including the actuator, of this disclosure may be applied in a variety of industrial applications, including but not limited to, automobiles, trucks, off-road vehicles, and other machines of the type having engines, automatic transmissions, and drivelines.

The disclosed clutch module actuator assembly offers a unique approach to control pawls generally adapted to engage the driving and driven members of clutch modules used in automatic transmissions. Use of a bellcrank in accordance with this disclosure may offer additional design opportunities for the control of clutch modules utilized in transmissions.

What is claimed is:

1. An actuator assembly (10) configured for use with a multi-mode clutch module (8) having a driving member (16) and a driven member (12), and a plurality of pawls (18) circumferentially positioned between the driving and driven members (16, 12); the actuator assembly (10) comprising:
an actuator ring (20) having a torque arm (52); the actuator ring (20) being configured to move between a plurality of angular positions, and adapted to selectively control movements of the plurality pawls (18) for locking and unlocking the driving and driven members (12, 16) together;
an actuator device (22) including a housing (24);
a translatable plunger (30) having a first end and a free end (32), the first end being secured within the housing (24); and
a bellcrank (40) pivotally affixed to the driven member (12), the driven member (12) being non-rotating, the bellcrank (40) having a first lever (44) and a second lever (46), the first and second levers (44, 46) being adapted to engage the free end (32) of the plunger (30) and the torque arm (52) for movement of the actuator ring (20) between the plurality of angular positions;
wherein the actuator assembly (10) moves the actuator ring (20) to selectively control the plurality of pawls (18) to allow multiple modes of engagement such that the driving member (16) and the driven member (12) are configured to allow multiple modes of operation of the multi-mode clutch module (8).

2. The actuator assembly (10) of claim 1, wherein the free end (32) of the plunger (30) engages the first lever (44) causing the bellcrank (40) to rotate in a first direction.

3. The actuator assembly (10) of claim 2, wherein the bellcrank (40) rotation in the first direction creates an interaction between the actuator assembly (10) and the bellcrank (40) causing the actuator ring (20) to rotate in a second direction.

4. The actuator assembly (10) of claim 3, wherein the actuator ring (20) having a return spring (23) anchored on the driven member (12) and the rotation in the second direction of the actuator ring (20) occurs against a return force of the return spring (23).

5. The actuator assembly (10) of claim 4, wherein the deactivation of the actuator device (22) causes a retraction of the plunger (30) and the actuator ring (20) being returned to its initial position by the return spring (23).

6. The actuator assembly (10) of claim 1, wherein the plurality of pawls (18) are each configured having a heel end (26) and a toe end (28) and the plurality of pawls (18) being arranged in a plurality of pairs of pawls (18A, 18B).

7. The actuator assembly (10) of claim 6, wherein the plurality of pairs of pawls (18A, 18B) are asymmetrically shaped and reversely identical, the heel end (26) being configured to interact with an actuator surface (21) of the actuator ring (20) and the toe end (28) being configured to selectively engage a plurality of notches (29) circumferentially spaced along the periphery of a hub (14).

8. The actuator assembly (10) of claim 7, wherein the plurality of pairs of pawls (18A, 18B) engage the plurality of notches (29) under the force of a pawl spring (34) and each pair of pawls (18A, 18B) being forced outwardly by the pawl spring (34).

9. An actuator assembly (10′) configured for use with a multi-mode clutch module (8′) having a driving member (16′) and a driven member (12′) and a plurality of pawls (18′) circumferentially positioned between the inner and driven members (16′, 12′); the actuator assembly (10′) comprising:
an actuator ring (20′) having a torque arm (52) extending orthogonally to a rotational axis (A′-A′) of the driving member (16′); the actuator ring (20′) being configured to move between a plurality of angular positions, and adapted to selectively control movements of the plurality of pawls (18′) for locking and unlocking the driving and driven members (12′, 16′) together;
an actuator device (22′);
a translatable plunger (30′) having a first end and a free end (32) being configured to extend parallel to the rotational axis (A′-A′) of the driving member (16′);
a bellcrank (40′) pivotally affixed to the driven member (12′), the bellcrank (40) having a first lever (44) and a second lever (46), the first and second levers (44, 46) being adapted to engage the free end (32′) of the plunger (30′) and the torque arm (52′) for movement of the actuator ring (20′) between the plurality of angular positions;
wherein the actuator assembly (10′) moves the actuator ring (20′) to selectively control the plurality of pawls (18′) to allow multiple modes of engagement such that driving member (16′) and the driven member (12′) are configured to allow multiple modes of operation of the multi-mode clutch module (8).

10. The actuator assembly (10′) of claim 9, wherein the free end (32′) of the plunger (30′) engages the first lever (44) causing the bellcrank (40′) to rotate in a first direction.

11. The actuator assembly (10′) of claim 10, wherein the bellcrank (40′) rotation in the first direction creates an interaction between the actuator assembly (10′) and the bellcrank (40′) causing the actuator ring (20′) to rotate in a second direction.

12. The actuator assembly (10′) of claim 11, wherein the actuator ring (20′) having a return spring (23) anchored on the driven member (12′) and the rotation in the second direction of the actuator ring (20′) occurs against a return force of the return spring (23).

13. The actuator assembly (10′) of claim 12, wherein the deactivation of the actuator device (22′) causes a retraction of the plunger (30′) and the actuator ring (20′) being returned to its initial position by the return spring (23).

14. The actuator assembly (10′) of claim 9, wherein the plurality of pawls (18′) are each configured having a heel end (26) and a toe end (28) and the plurality of pawls (18′) being arranged in a plurality of pairs of pawls (18A, 18B)

15. The actuator assembly (10′) of claim 14, wherein the plurality of pairs of pawls (18A, 18B) are asymmetrically shaped and reversely identical, the heel end (26) being configured to interact with an actuator surface (21) of the actuator ring (20) and the toe end (28) being configured to selectively engage a plurality of notches (29) circumferentially spaced along the periphery of a hub (14), the plurality of pairs of pawls (18A, 18B) being configured to engage the plurality of notches (29) under the force of a pawl spring (34) and each pair of pawls (18A, 18B) being forced axially outward by the pawl spring (34).
